(19) United States
(12) Patent Application Publication
(10) Pub. No.: US 2020/0097722 A1
(43) Pub. Date: Mar. 26, 2020

(54) INFORMATION PROCESSING DEVICE, TRANSPORT APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventors: Takahiro MINAMIKAWA, Kanagawa (JP); Yoshimi UEZU, Kanagawa (JP); Kunitoshi YAMAMOTO, Kanagawa (JP); Junichi TAMURA, Kanagawa (JP)

(73) Assignee: FUJI XEROX CO., LTD., Tokyo (JP)

(21) Appl. No.: 16/572,616

(22) Filed: Sep. 17, 2019

(30) Foreign Application Priority Data
Sep. 25, 2018 (JP) 2018-178495

(51) Int. Cl. G06K 9/00; G06T 7/70

(52) U.S. Cl. CPC G06K 9/00664; G06T 7/70

(57) ABSTRACT

An information processing device includes a determining unit and a setting unit. The determining unit determines a position of a second apparatus after a first apparatus comes into contact with the second apparatus. The first apparatus transports an object to or from the second apparatus. The setting unit sets a target location for the first apparatus in accordance with the determined position of the second apparatus.

### CROSS-REFERENCE TO RELATED APPLICATIONS

This application is based on and claims priority under 35 USC 119 from Japanese Patent Application No. 2018-178495 filed Sep. 25, 2018.

### BACKGROUND

### (i) Technical Field

The present disclosure relates to information processing devices, transport apparatuses, information processing methods, and non-transitory computer readable media.

### (ii) Related Art

For example, Japanese Patent No. 5018458 states that, when a new environmental map is created in simultaneous localization and mapping (SLAM) to deal with a change in self-location estimation accuracy or orientation of a robot, the coordinate system of the new environmental map deviates from the coordinate system of the old environmental map. Thus, Japanese Patent No. 5018458 discloses that, when focusing on an obstacle cell included in one of the two environmental maps, that is, the new and old environmental maps, the one environmental map is set as an actual environmental map by performing a coordinate conversion automatically with a small calculation amount in view of a positional deviation and a rotational deviation to the nearest obstacle cell in the other environmental map.

### SUMMARY

Aspects of non-limiting embodiments of the present disclosure relate to setting an object delivery apparatus as a target location for a transport apparatus, which moves to transport an object, even when the delivery apparatus is positionally displaced due to the transport apparatus coming into contact with the delivery apparatus.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing device including a determining unit and a setting unit. The determining unit determines a position of a second apparatus after a first apparatus comes into contact with the second apparatus. The first apparatus transports an object to or from the second apparatus. The setting unit sets a target location for the first apparatus in accordance with the determined position of the second apparatus.

### BRIEF DESCRIPTION OF THE DRAWINGS

An exemplary embodiment of the present disclosure will be described in detail based on the following figures, wherein:

FIG. 1 is an external view of a transport apparatus and a delivery apparatus according to an exemplary embodiment;

FIG. 2 illustrates an example of a functional configuration of the transport apparatus;

FIG. 3 illustrates an example of a hardware configuration of the transport apparatus;

FIG. 4 is a flowchart illustrating an example of the operation of the transport apparatus; and

FIGS. 5A and 5B illustrate an example where a target location is corrected.

### DETAILED DESCRIPTION

1. Configuration

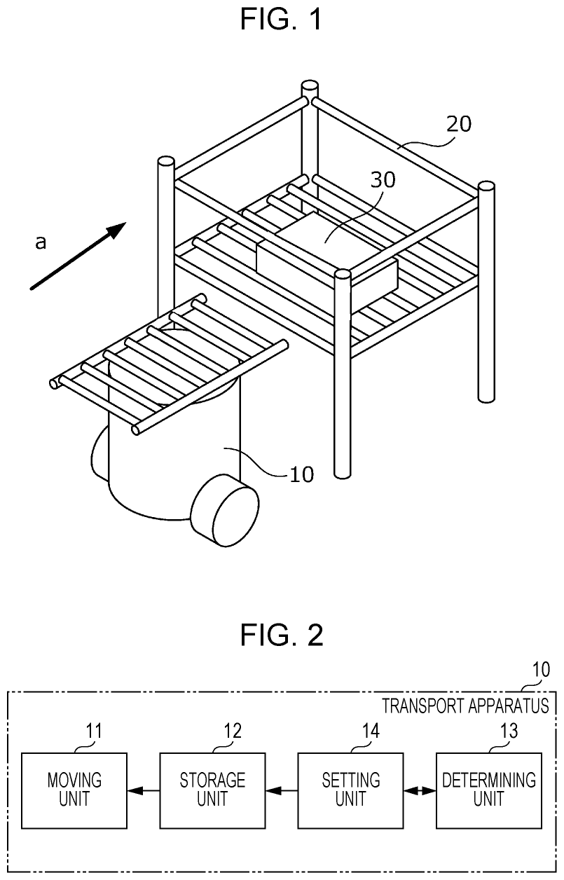

FIG. 1 is an external view of a transport apparatus 10 and a delivery apparatus 20 according to an exemplary embodiment. The transport apparatus 10 transports an object 30 to a target location by moving in a state where the transport apparatus 10 carries the object 30. The transport apparatus 10 may have any shape so long as it is movable. The delivery apparatus 20 receives or delivers the object 30 from or to the transport apparatus 10. The delivery apparatus 20 may have any shape so long as it delivers or receives the object 30 to or from the transport apparatus 10. For example, in a factory that manufactures a certain product, the transport apparatus 10 transports a component of the product to the delivery apparatus 20, which is stationary and serves as a target location, so as to deliver the component to the delivery apparatus 20, or moves to the stationary delivery apparatus 20, which serves as a target location and has the component loaded thereon, so as to receive the component from the delivery apparatus 20. The transport apparatus 10 and the delivery apparatus 20 individually include delivery mechanisms for delivering and receiving the object 30 to and from each other.

When the transport apparatus 10 and the delivery apparatus 20 deliver and receive the object 30 to and from each other in this manner, the delivery mechanisms of the transport apparatus 10 and the delivery apparatus 20 are docked with each other so as to be brought into contact with each other. As the delivery mechanisms are repeatedly brought into contact with each other, the contact position may sometimes change as a result of the delivery apparatus 20 receiving an external force from the transport apparatus 10. The position of the delivery apparatus 20 is set in advance assuming that the delivery apparatus 20 is stationary, and the transport apparatus 10 moves to that position as a target location. Thus, when the position of the delivery apparatus 20 changes, it may be difficult for the transport apparatus 10 to come into contact with the delivery apparatus 20, sometimes making it difficult to deliver or receive the object 30 to or from the delivery apparatus 20.

FIG. 2 illustrates an example of a functional configuration of the transport apparatus 10. The transport apparatus 10 includes a moving unit 11, a storage unit 12, a determining unit 13, and a setting unit 14. The moving unit 11 causes the transport apparatus 10 to move autonomously along, for example, a surface of a structure. In autonomous movement, an apparatus moves autonomously without a specific command from a human. The structure is, for example, a building, a road, or a ground surface along which the transport apparatus 10 is movable. The surface of the structure is a surface on which the transport apparatus 10 moves (referred to as “movement surface” hereinafter) and is, for example, an indoor floor surface or an outdoor road surface.

The storage unit 12 stores the target location for the transport apparatus 10, that is, a location to be reached by the transport apparatus 10 for coming into contact with the delivery apparatus 20 to deliver or receive the object 30 thereto or therefrom. The moving unit 11 causes the transport apparatus 10 to move toward this target location.

The determining unit 13 determines the position of the delivery apparatus 20 that has changed as a result of the transport apparatus 10 coming into contact with the delivery apparatus 20.

The setting unit 14 sets the target location for the transport apparatus 10 in accordance with the position of the delivery apparatus 20 determined by the determining unit 13 and writes the set target location in the storage unit 12. When the transport apparatus 10 is to subsequently move toward the delivery apparatus 20, the moving unit 11 causes the transport apparatus 10 to move toward this newly-written target location.

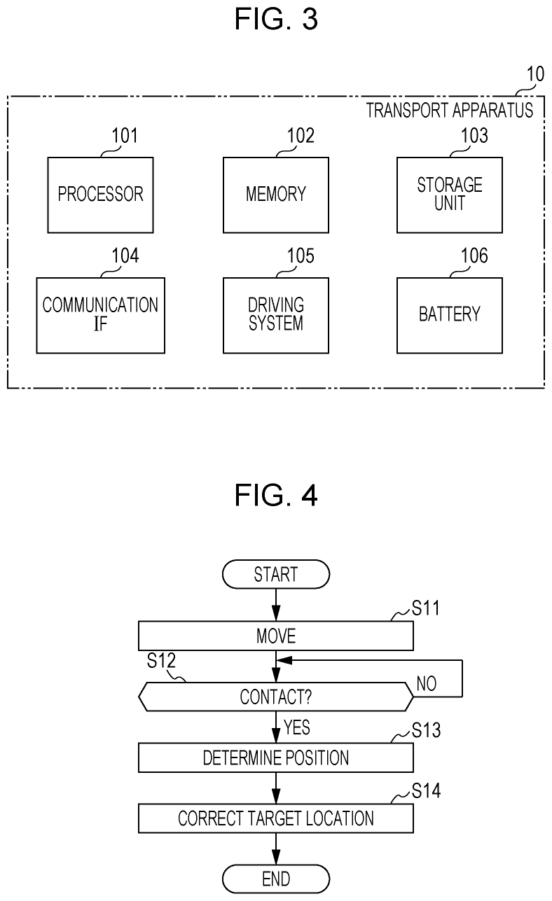

FIG. 3 illustrates an example of a hardware configuration of the transport apparatus 10. A processor 101 controls other components of the transport apparatus 10 and corresponds to an example of an information processing device according to an exemplary embodiment of the present disclosure. A memory 102 functions as a work area used by the processor 101 for executing a program, and includes, for example, a random access memory (RAM). A storage unit 103 stores various types of programs and data and includes, for example, a solid state drive (SSD) or a hard disk drive (HDD). A communication interface (IF) 104 communicates with another device in accordance with a predetermined wireless or wired communication standard (such as Wi-Fi (registered trademark), Bluetooth (registered trademark), or Ethernet (registered trademark)).

A driving system 105 is a mechanism for causing the transport apparatus 10 to move along the surface of the structure (such as a floor surface or a road surface). The driving system 105 includes, for example, multiple wheels, tires attached to these wheels, a motor for driving these wheels, and a mechanism that changes the orientation of these wheels. The delivery mechanism for causing the transport apparatus 10 to deliver and receive the object 30 to and from the delivery apparatus 20 is also included in the driving system 105. A battery 106 supplies electric power for driving other components, such as the processor 101 and the driving system 105, and is, for example, a lithium-ion battery.

In this example, the storage unit 103 also stores a program for controlling the driving system 105 to cause the transport apparatus 10 to move autonomously (referred to as “autonomous movement program” hereinafter). The processor 101 executes this program so that the function shown in FIG. 1 is implemented in the transport apparatus 10. The storage unit 103 stores map information indicating a movable range of the transport apparatus 10 and designated movement paths. The autonomous movement program refers to this map information so as to perform an autonomous movement process. The transport apparatus 10 moves while estimating its location by combining odometry information with the map information. Odometry is a generic term for a method of determining movement amounts of wheels and a steering wheel of a wheel-based mobile robot by calculating rotational angles thereof and estimating the location of the robot from a cumulative calculation of the movement amounts. Odometry information is a generic term for information used for estimating the location in odometry. The storage unit 103 is an example of the storage unit 12. The driving system 105 is an example of the moving unit 11. The processor 101 executing a movement control program is an example of the determining unit 13 and the setting unit 14.

2. Operation

Referring to FIG. 4, in step S11, the moving unit 11 first causes the transport apparatus 10 to move in accordance with the autonomous movement program toward the target location stored in the storage unit 12.

If it is determined that the transport apparatus 10 has reached the position of the delivery apparatus 20 and has come into contact with the delivery apparatus 20 (YES in step S12), the determining unit 13 determines the position of the delivery apparatus 20, which has changed due to the contact, in step S13. Specifically, the determining unit 13 calculates the amount and the direction of movement of the delivery apparatus 20 in accordance with a so-called equation of motion (first law of motion, second law of motion, third law of motion) by using the masses of the transport apparatus 10 and the delivery apparatus 20, the speed of the transport apparatus 10, the friction between the delivery apparatus 20 and the movement surface, the contact position or the contact direction between the transport apparatus 10 and the delivery apparatus 20, the mass of the object 30 transported by the transport apparatus 10, or the mass of the object 30 loaded on the delivery apparatus 20, thereby determining the position of the delivery apparatus 20. In this case, among the masses of the transport apparatus 10 and the delivery apparatus 20, the speed of the transport apparatus 10, the friction between the delivery apparatus 20 and the movement surface, the contact position or the contact direction between the transport apparatus 10 and the delivery apparatus 20, the mass of the object 30 transported by the transport apparatus 10, and the mass of the object 30 loaded on the delivery apparatus 20, a condition that does not have to be taken into account due to being small enough to be negligible is excluded. In other words, the determining unit 13 may perform the aforementioned calculation by using at least one of the masses of the transport apparatus 10 and the delivery apparatus 20, the speed of the transport apparatus 10, the friction between the delivery apparatus 20 and the movement surface, the contact position or the contact direction between the transport apparatus 10 and the delivery apparatus 20, the mass of the object 30 transported by the transport apparatus 10, and the mass of the object 30 loaded on the delivery apparatus 20.

In step S14, the setting unit 14 sets the target location for the transport apparatus 10 in accordance with the position of the delivery apparatus 20 determined by the determining unit 13, and writes the set target location in the storage unit 12. The storage unit 12 is accessible by the transport apparatus 10 and other transport apparatuses. When the moving unit 11 of the transport apparatus 10 or another transport apparatus subsequently causes the relevant transport apparatus to move toward the delivery apparatus 20, the moving unit 11 causes the relevant transport apparatus to move toward the newly-written target location.

2.1. Operational Example

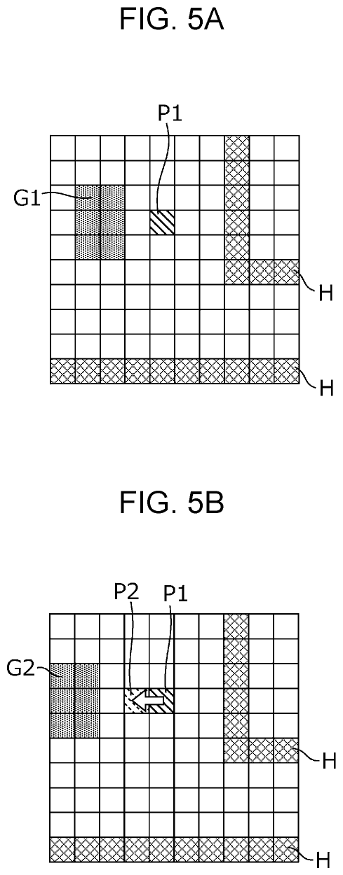

FIGS. 5A and 5B are plan views when a plane in which the transport apparatus 10 and the delivery apparatus 20 exist are viewed from above. In FIG. 5A, the transport apparatus 10 is located at a position P1, and the delivery apparatus 20 is located at a position G1. Reference sign “H” denotes an external object. In FIG. 5B, it is assumed that, when the transport apparatus 10 moves to a position P2, the transport apparatus 10 comes into contact with the delivery apparatus 20 and causes the delivery apparatus 20 to move to a position G2. In this case, the setting unit 14 writes the position G2 of the delivery apparatus 20 determined by the determining unit 13 in the storage unit 12.

3. Modifications

The above-described exemplary embodiment is merely an example of the present disclosure and may be modified as follows. Furthermore, the above-described exemplary embodiment and modifications to be described below may be combined, where appropriate.

3.1. First Modification

The determining unit 13 may detect the distance and the direction between the delivery apparatus 20 and a facility located in the vicinity of the delivery apparatus 20 by using a radio wave, such as an infrared ray, after the transport apparatus 10 comes into contact with the delivery apparatus 20 to deliver or receive the object 30 thereto or therefrom, and may determine the position of the delivery apparatus 20 by using the detection result. Specifically, the determining unit 13 detects the distance and the direction between the delivery apparatus 20 and the facility located in the vicinity of the delivery apparatus 20 after the transport apparatus 10 comes into contact with the delivery apparatus 20 to deliver or receive the object 30 thereto or therefrom. In this case, the facility located in the vicinity of the delivery apparatus 20 is, for example, a wall, the position of which is already known. The determining unit 13 may determine the distance and the direction between the delivery apparatus 20 and the facility located in the vicinity of the delivery apparatus 20 by using the detection result of the distance and the direction between the delivery apparatus 20 and the facility located in the vicinity of the delivery apparatus 20 with reference to the position of the determining unit 13. Since the position of the facility located in the vicinity of the delivery apparatus 20 is already known, the position of the delivery apparatus 20 may also be calculated.

3.2. Second Modification

Although the above example relates to a case where the transport apparatus 10 comes into contact with the delivery apparatus 20 when delivering or receiving the object 30 thereto or therefrom, the same applies to a case where the transport apparatus 10 comes into contact with the delivery apparatus 20 before delivering or receiving the object 30 thereto or therefrom. An example includes a case where the transport apparatus 10, while moving, accidentally comes into contact with the delivery apparatus 20. In this case, when the determining unit 13 determines that the transport apparatus 10 has reached the position of the delivery apparatus 20 and has come into contact with the delivery apparatus 20, the determining unit 13 determines the position of the delivery apparatus 20 that has changed due to the contact. Specifically, the determining unit 13 calculates the amount and the direction of movement of the delivery apparatus 20 in accordance with a so-called equation of motion (first law of motion, second law of motion, third law of motion) by using the masses of the transport apparatus 10 and the delivery apparatus 20, the speed of the transport apparatus 10, the friction between the delivery apparatus 20 and the movement surface, the contact position or the contact direction between the transport apparatus 10 and the delivery apparatus 20, the mass of the object 30 transported by the transport apparatus 10, or the mass of the object 30 loaded on the delivery apparatus 20, thereby determining the position of the delivery apparatus 20. In this case, among the masses of the transport apparatus 10 and the delivery apparatus 20, the speed of the transport apparatus 10, the friction between the delivery apparatus 20 and the movement surface, the contact position or the contact direction between the transport apparatus 10 and the delivery apparatus 20, the mass of the object 30 transported by the transport apparatus 10, and the mass of the object 30 loaded on the delivery apparatus 20, a condition that does not have to be taken into account due to being small enough to be negligible is excluded. In other words, the determining unit 13 may perform the aforementioned calculation by using at least one of the masses of the transport apparatus 10 and the delivery apparatus 20, the speed of the transport apparatus 10, the friction between the delivery apparatus 20 and the movement surface, the contact position or the contact direction between the transport apparatus 10 and the delivery apparatus 20, the mass of the object 30 transported by the transport apparatus 10, and the mass of the object 30 loaded on the delivery apparatus 20. The setting unit 14 sets the target location for the transport apparatus 10 in accordance with the position of the delivery apparatus 20 determined by the determining unit 13, and writes the set target location in the storage unit 12. When the moving unit 11 subsequently causes the transport apparatus 10 to move toward the delivery apparatus 20, the moving unit 11 causes the transport apparatus 10 to move toward the newly-written target location.

3.3. Third Modification

The determining unit 13 may determine the position of the delivery apparatus 20 based on an image-recognition result of a predetermined surface obtained by the delivery apparatus 20 after the transport apparatus 10 comes into contact with the delivery apparatus 20 to deliver or receive the object 30 thereto or therefrom. In this case, the transport apparatus 10 includes an imaging unit, such as a camera. The imaging unit is provided at the bottom surface of the transport apparatus 10 that faces the surface of the structure along which the transport apparatus 10 autonomously moves. The imaging unit captures an image of a part of the surface that has a specific positional relationship with the transport apparatus 10. The determining unit 13 compares image data output from the imaging unit with comparison data for every position preregistered in the storage unit 12, thereby determining the position of the apparatus. The comparison data expresses an image of each position of the surface of the structure or expresses the characteristics of the image. For example, the comparison data expresses a fine irregular pattern (referred to as “random pattern” hereinafter) on the floor surface. As a comparison process using a random pattern, for example, the method described in Japanese Unexamined Patent Application Publication No. 2005-10581 is used. For example, a random pattern is a pattern in which fibers intricately intertwine with each other, as seen in a micrograph of the surface of a nonwoven fabric, or a pattern as seen in a micrograph of the surface of stainless steel. A random pattern is not formed intentionally, but is formed unintentionally from the properties of an item itself, in a manufacturing process, or after the manufacturing process. It is highly unlikely that multiple items having exactly the same random pattern exist. It is also conceivably difficult to form the same random pattern intentionally. In other words, even items manufactured and distributed after undergoing the same process have microscopically different random patterns from item to item. The position in autonomous movement is ascertained by performing this random-pattern-based comparison process.

3.4. Fourth Modification

In a case where the amount of change in the determined position of the delivery apparatus 20 exceeds a threshold value, the setting unit 14 sets the target location for the transport apparatus 10 in accordance with the position. In other words, if the amount of change in the determined position of the delivery apparatus 20 is small and is within the threshold value, the setting unit 14 does not change the target location for the transport apparatus 10. In contrast, if the amount of change in the determined position of the delivery apparatus 20 exceeds the threshold value, the setting unit 14 changes the target location for the transport apparatus 10.

3.5. Fifth Modification

In the above-described exemplary embodiment, the transport apparatus 10 has the shape shown in FIG. 1. However, the shape of the transport apparatus 10 is not limited to that shown in FIG. 1.

3.6. Sixth Modification

In the above-described exemplary embodiment, the program executed by the processor 101 of the transport apparatus 10 may be downloaded via a communication line, such as the Internet. Alternatively, the program may be provided by being stored in a computer readable storage medium, which includes a magnetic storage medium (such as a magnetic tape or a magnetic disk), an optical storage medium (such as an optical disk), a magneto-optical storage medium, and a semiconductor memory.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing device comprising:
a determining unit that determines a position of a second apparatus after a first apparatus comes into contact with the second apparatus, the first apparatus transporting an object to or from the second apparatus;
a setting unit that sets a target location for the first apparatus in accordance with the determined position of the second apparatus.

2. The information processing device according to claim 1,
wherein, in a case where the first apparatus comes into contact with the second apparatus, the determining unit determines the position of the second apparatus by calculating an amount and a direction of movement of the second apparatus caused by the contact.

3. The information processing device according to claim 2,
wherein the determining unit determines the position of the second apparatus by performing a calculation using at least one of masses of the first apparatus and the second apparatus, a speed of the first apparatus, friction between the second apparatus and a movement surface, and a contact position or a contact direction between the first apparatus and the second apparatus.

4. The information processing device according to claim 2,
wherein the determining unit determines the position of the first apparatus by performing a calculation using a mass of the object, the object being delivered to the second apparatus by the first apparatus or waiting at the second apparatus to be picked up by the first apparatus.

5. The information processing device according to claim 3,
wherein the determining unit determines the position of the first apparatus by performing a calculation using a mass of the object, the object being delivered to the second apparatus by the first apparatus or waiting at the second apparatus to be picked up by the first apparatus.

6. The information processing device according to claim 1,
wherein the determining unit determines the position of the second apparatus by using a detection result of a distance and a direction between the second apparatus and a facility located in a vicinity of the second apparatus, the detection result being obtained after the first apparatus comes into contact with the second apparatus to deliver or receive the object to or from the second apparatus.

7. The information processing device according to claim 1,
wherein, in a case where the first apparatus comes into contact with the second apparatus before the object is delivered to or picked up from the second apparatus, the determining unit determines the position of the second apparatus by calculating an amount and a direction of movement of the second apparatus caused by the contact.

8. The information processing device according to claim 7,
wherein, in a case where the first apparatus comes into contact with the second apparatus before the object is delivered to or picked up from the second apparatus, the determining unit determines a position of the first apparatus by calculating an amount and a direction of movement of the first apparatus caused by the contact.

9. The information processing device according to claim 7,
wherein the determining unit determines the position by performing a calculation using at least one of masses of the first apparatus and the second apparatus, a speed of the first apparatus, friction between the second apparatus and a movement surface, and a contact position or a contact direction between the first apparatus and the second apparatus.

10. The information processing device according to claim 8,
wherein the determining unit determines the position by performing a calculation using at least one of masses of the first apparatus and the second apparatus, a speed of the first apparatus, friction between the second apparatus and a movement surface, and a contact position or a contact direction between the first apparatus and the second apparatus.

11. The information processing device according to claim 7,
wherein the determining unit determines the position of the first apparatus by performing a calculation using a mass of the object, the object being delivered to the second apparatus by the first apparatus or waiting at the second apparatus to be picked up by the first apparatus.

12. The information processing device according to claim 8,
wherein the determining unit determines the position of the first apparatus by performing a calculation using a mass of the object, the object being delivered to the second apparatus by the first apparatus or waiting at the second apparatus to be picked up by the first apparatus.

13. The information processing device according to claim 9,
wherein the determining unit determines the position of the first apparatus by performing a calculation using a mass of the object, the object being delivered to the second apparatus by the first apparatus or waiting at the second apparatus to be picked up by the first apparatus.

14. The information processing device according to claim 10,
wherein the determining unit determines the position of the first apparatus by performing a calculation using a mass of the object, the object being delivered to the second apparatus by the first apparatus or waiting at the second apparatus to be picked up by the first apparatus.

15. The information processing device according to claim 1,
wherein the determining unit determines the position of the second apparatus based on an image-recognition result of a predetermined surface obtained by the second apparatus after the first apparatus comes into contact with the second apparatus to deliver or receive the object to or from the second apparatus.

16. The information processing device according to claim 1, further comprising:
a storage unit that stores the set target location in an accessible manner by the first apparatus.

17. The information processing device according to claim 1,
wherein, in a case where an amount of change in the determined position of the second apparatus exceeds a threshold value, the setting unit sets the target location for the first apparatus in accordance with the position.

18. A transport apparatus comprising:
the iformation processing device according to claim 1.

19. An information processing method comprising:
determining a position of a second apparatus after a first apparatus comes into contact with the second apparatus, the first apparatus transporting an object to or from the second apparatus; and
setting a target location for the first apparatus in accordance with the determined position of the second apparatus.

20. A non-transitory computer readable medium storing a program causing a computer to execute a process, the process comprising:
determining a position of a second apparatus after a first apparatus comes into contact with the second apparatus, the first apparatus transporting an object to or from the second apparatus; and
setting a target location for the first apparatus in accordance with the determined position of the second apparatus.
